(19) United States
(12) Patent Application Publication
(10) Pub. No.: US 2012/0137214 A1
(43) Pub. Date: May 31, 2012

(54) SYSTEMS AND METHODS FOR PRODUCING A PLURALITY OF CUSTOMIZED INTEGRATED MISSAL BULLETINS BASED ON COMMON BASE CONTENT

(75) Inventor: John Michael Haubrich, Quincy, IL (US)

(73) Assignee: Haubrich-Rupp Partnership, Quincy, IL (US)

(21) Appl. No.: 12/955,889

(22) Filed: Nov. 29, 2010

(51) Int. Cl. G06F 17/00

(52) U.S. Cl. 715/243

(57) ABSTRACT

A system and method for producing an integrated missal bulletin having a base content origination system, a first and a second local entity system, and a production system. The base content origination system compiles the base content portions and assigns each base content portion a base content portion reference identifier and transmitting the compiled base content with the associated base content portion reference identifiers to the production system. The first and second local entity systems receiving local entity content and local integration instructions and them to the production system. The production system has an integration module with computer readable instructions for selecting a base content portions from the base content responsive to the base content portion reference identifiers as provided by the first local integration instructions, arranging the local content with the selected base content portion, and creating first and second integrated missal bulletin document files that are different as containing the arranged local content with the selected first base content portion for each first and second local entity systems. The production system produces a first integrated missal bulletin from the created first integrated missal bulletin document file and produces a second integrated missal bulletin from the created second integrated missal bulletin document file.

### FIELD

The present disclosure relates to publishing systems and methods and, more specifically, to systems and methods for publishing and distributing an integrated missal bulletin for weekly religious ceremonies.

### BACKGROUND

The statements in this section merely provide background information related to the present disclosure and may not constitute prior art.

The current art provides for local organizations that are members of a regional, national or international group to receive base content from such overseeing group for local activities, meetings and services. The local organizations generally utilize the base content or base information that it receives from the regional, national or international group and add local information, content, agendas, advertisements, announcements, for example, in the preparation of a local brochure, meeting papers, and agenda. The final bulletin or meeting product that is produced varies by local organization as to the character, format and content and often lacks consistency that is desired by the overseeing group.

One example of such a current practice is that of religious organizations/denominations such as the Catholic Church. The current practice is for the international, national or regional offices of the church to provide a missal containing ritual text, preface, rubric, praise, response, image, poem, chant, musical setting, participation aid, rite, scripture, prayer and music score for period of multiple weeks, quarterly, biannually, or annually. For example, the United States Conference of Catholic Bishops (USCCB) may issue one or more missals for use by local churches periodically throughout the year. These updated missals are provided to the local churches as the base content for use by the local churches. These missals are often printed centrally and transported or shipped to each local church for their use. The missals are provided to each local church at which each pastor is authorized to utilize the missals in the preparation of weekly services. Furthermore the overseeing offices may provide rules or guidelines to each local church to be followed by each pastor to aid in preparing the local services and in the use of the missal therein.

Each local church prepares its own bulletin for one or more services that are held during that week based on the needs of the particular day and pastor's planned ceremony, and accumulates local announcements, advertisements, and other local content. The weekly bulletin is prepared with references to the then-current missal such as to a particular ritual text, preface, rubric, praise, response, image, poem, chant, musical setting, participation aid, rite, scripture, prayer and music score that is contained therein. Each weekly bulletin is printed locally and distributed for each applicable religious service and thereafter disposed when no longer required, such as on a weekly basis. The missals are retained until superseded by another one sent from the overseeing office and the old missals are then disposed as they are no longer applicable for referencing. The weekly bulletin provides schedule or agenda for each weekly religious service with references to portions of the missal. For each service, a participant in a local church service uses the local bulletin as an agenda or guide to the service and refers to the separate missal when referenced in the local bulletin during the course of the service. This requires that each participant has to refer to the bulletin for the agenda and the next missal reference, refer to the missal by page number or reference number of ritual text, preface, rubric, praise, response, image, poem, chant, musical setting, participation aid, rite, scripture, prayer and music score, then back again to the agenda, repeating this process numerous times during the service.

As the missals can be updated several times a year, and each weekly bulletin is produced locally by each local church for each service during the week, the local church staff is required to constantly change its references to the missals and manage the change out those missals. Each local church is tasked with preparing each bulletin and having it locally printed either in house or using local printing shops with few economies of scale or consolidated or integrated efforts. These current local practices are inefficient as to the use of personnel time as well as creating paper products that must be prepared, managed and destroyed on a never ending basis.

### SUMMARY

The inventor hereof has succeeded at designing systems and methods for providing a weekly integrated missal and bulletin for use by two or more local churches, but that is customized for each local entities needs and requirements. The integrated product having the integration of the missal within the bulletin includes not only the local content of each church or entity, but the base content that is standardized base content for all of the numerous local entities, but that is directly related to and integrated with the bulletin. These integrated documents such as an integration of the missal and bulletin, can include all necessary information for the weekly or monthly meeting or ceremony without a requirement for referencing or using a separate base content document, such as a missal or hymnal. The integrated document will provide each local church with a single publication such that no other publication is required for each local service. Furthermore, the integrated document can be centrally printed to reduce costs, or can be electronically transmitted for local printing, for displaying or for transmitting to local personal devices for personal viewing.

According to one aspect, A system and method for producing an integrated missal bulletin having a base content origination system, a first and a second local entity system, and a production system. The base content origination system compiles the base content portions and assigns each base content portion a base content portion reference identifier and transmitting the compiled base content with the associated base content portion reference identifiers to the production system. The first and second local entity systems receiving local entity content and local integration instructions and them to the production system. The production system has an integration module with computer readable instructions for selecting a base content portions from the base content responsive to the base content portion reference identifiers as provided by the first local integration instructions, arranging the local content with the selected base content portion, and creating first and second integrated missal bulletin document files that are different as containing the arranged local content with the selected first base content portion for each first and second local entity systems. The production system produces a first integrated missal bulletin from the created first integrated missal bulletin document file and produces a second integrated missal bulletin from the created second integrated missal bulletin document file.

According to another aspect, a system for producing an integrated missal bulletin including a production system having a processor, a memory, a first interface, and a second interface. The first interface receives base content having a plurality of portions from a base content originator. The second interface receives local content from two or more different local content entities and for receiving local integration instructions from each of the two more different local content entities. Each of the local integration instructions includes one or more references to at least one of the plurality of portions of the base content. The production system has an integration module with computer readable instructions for configuring the processor, memory and first and second interface for performing the method including receiving the base content at the first interface, storing the received base content in the memory, receiving over the second interface first local integration instructions and first local content from a first local content entity and second local integration instructions and second local content from a second local content entity. The production system further is configured for selecting as a first base content portion a first portion of the base content corresponding at least one of the first base content portion references as a function of the first local integration instruction, arranging the first local content with the selected first base content portion as a function of the first local integration instruction, and creating a first integrated missal bulletin document file containing the arranged first local content with the selected first base content portion. The production system also is configured for selecting as a second base content portion a portion of the base content corresponding at least one of the second base content portion references as a function of the second local integration instruction, arranging the second local content with the selected second base content portion as a function of the second local integration instruction, and creating a second integrated missal bulletin document file containing the arranged second local content with the selected second base content portion, wherein the second integrated missal bulletin document file is different than the first integrated missal bulletin document file.

According to another aspect, a method of producing an integrated missal bulletin using a production system having a processor, a memory, a first interface receiving base content having a plurality of portions from a base content originator, and a second interface for receiving local content from two or more different local content entities and for receiving local integration instructions from each of the two more different local content entities, each of the local integration instructions including one or more references to at least one of the plurality of portions of the base content. The production system having an integration module with computer readable instructions for configuring the processor, memory and first and second interface, performing the method including receiving the base content at the first interface, and storing the received base content in the memory. The method includes receiving over the second interface first local integration instructions and first local content from a first local content entity and second local integration instructions and second local content from a second local content entity, selecting as a first base content portion a portion of the base content corresponding at least one of the first content portion references as a function of the first local integration instruction, arranging the first local content with the selected first base content portion as a function of the first local integration instruction, creating a first integrated missal bulletin document file containing the arranged first local content with the selected first base content portion. The method also includes selecting as a second base content portion a portion of the base content corresponding at least one of the second base content portion references as a function of the second local integration instruction, arranging the second local content with the selected second base content portion as a function of the second local integration instruction, and creating a second integrated missal bulletin document file containing the arranged second local content with the selected second base content portion, wherein the second integrated missal bulletin document file being different than the first integrated missal bulletin document file.

According to yet another aspect, a system for producing an integrated missal bulletin having a base content origination system, a first and a second local entity system, and a production system. The base content origination system having a base content processor, base content memory, a first origination system interface and a second origination system interface. The first origination system interface receiving a plurality of base content portions. The processor receiving the base content portions and compiling the base content portions into base content including assigning each base content portion a base content portion reference identifier, and storing the base content with the compiled base content portions in the memory and transmitting the compiled base content with the associated base content portion reference identifiers over a second origination system interface. The first local entity system having a first local entity processor, a memory, a first local user interface and a first local entity network interface. The first local interface receiving first local entity content and first local integration instructions from a first user. The first local entity network interface transmitting the received first local entity content and the first local integration instructions. The second local entity system having a second local entity processor, a memory, a second local user interface and a second local entity network interface. The second local interface receiving second local entity content and second local integration instructions from a second user, the second local entity network interface transmitting the received second local entity content and the second local integration instructions, wherein each of the first and second local integration instructions includes one or more defined base content portion reference identifiers. The production system has a processor, a memory, a first interface receiving the transmitted compiled base content, and a second interface for receiving the first local content and first local integration instructions from the first local entity system and the second local content and second local integration instructions from the second local entity system. The production system having an integration module with computer readable instructions for configuring the processor, the memory and first and second interface of the production system for performing the method including receiving the compiled base content at the first production system interface, storing the received compiled base content in the memory including each associated base content portion reference identifiers, and receiving over the second production system interface the first local integration instructions and the first local content from the first local entity system and the second local integration instructions and the second local content from the second local entity system. The production system also selecting a first base content portion from the base content responsive to the first base content portion reference identifier as provided by the first local integration instruction, arranging the first local content with the first selected base content portion, and creating a first integrated missal bulletin document file containing the arranged first local content with the selected first base content portion. The production system further selecting a second base content portion from the base content responsive to the second base content portion reference identifier as provided by the second local integration instruction, arranging the second local content with the second selected base content portion, and creating a second integrated missal bulletin document file containing the arranged second local content with the selected second base content portion, the second integrated missal bulletin document file being different than the first integrated missal bulletin document file. The production system produces a first integrated missal bulletin from the created first integrated missal bulletin document file and produces a second integrated missal bulletin from the created second integrated missal bulletin document file.

A method of producing an integrated missal bulletin in a system having a base content origination system, a first and a second local entity system, and a production system. The base content origination system having a base content processor, base content memory, a first origination system interface and a second origination system interface. The method of the base content origination system comprising receiving over the first origination system interface a plurality of base content portions from one or more base content originators, compiling by the processor the received base portions as base content including assigning each base content portion a base content portion reference identifier, and transmitting over the second origination system interface the compiled base content with the assigned based content portion reference identifiers over the second base content interface. The first local entity system having a first local entity processor, memory, first local user interface and a first entity network interface and performing the method of receiving first local entity content and first local integration instruction over the first local user interface, and transmitting the received first local entity content and the first local integration instructions over a first entity network interface. The second local entity system having a second local entity processor, memory, second local user interface and a second entity network interface and performing the method of receiving second local entity content and second local integration instructions over the second local user interface, and transmitting the received second local entity content and the second local integration instructions over the second local entity network interface, wherein each of the first and second local integration instructions including one or more defined base content portion reference identifiers. The production system having a processor, a memory, a first interface and a second interface and an integration module with computer readable instructions for configuring the processor, memory and first and second interfaces. The production system performing the method of receiving over the first interface the transmitted compiled base content with the based content portion reference identifiers, and receiving over the second interface the first local content and first local integration instructions from the first local entity system and the second local content and second local integration instructions from the second local entity system. The integration module performing the method of receiving the compiled base content at the first interface including the associated base content portion reference identifiers, and storing the received compiled base content in the memory along with the associated base content portion reference identifiers. The integration module further performing the method of receiving over the second interface the first local integration instructions and the first local content from the first local entity system and the second local integration instructions and the second local content from the second local entity system, selecting a first base content portion from the base content responsive to the first base content portion reference identifier as provided by the first local integration instruction, arranging the first local content with the first selected portions of the base content, and creating a first integrated missal bulletin document file containing the arranged first local content with the selected first base content portions. It further performs the method of selecting a second base content portion from the base content responsive to the second base content portion reference identifier as provided by the second local integration instruction, arranging the second local content with the second selected portions of the base content, and creating a second integrated missal bulletin document file containing the arranged second local content with the selected second base content portions, the second integrated missal bulletin document file being different than the first integrated missal bulletin document file. The production system further producing a first integrated missal bulletin from the created first integrated missal bulletin document file; and producing a second integrated missal bulleting from the created second integrated missal bulletin document file.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a block diagram of a production system for customized integrated missal bulletins for each of a plurality of local entities using selected portions of common base content according to one exemplary embodiment.

FIG. 2 is block diagram of a system for producing customized integrated missal bulletins having a single base content origination system and a plurality of production systems each of which serves a plurality of local entities according to one exemplary embodiment.

FIG. 3 is a flow chart of a method for producing a customized integrated missal bulletin for each of a plurality of local entities using common base having a plurality of base content portions according to one exemplary embodiment.

FIG. 4 is a block diagram of a system for producing local entity customized integrated missal bulletins having multiple supervisory production systems managing the formation of base content according to another exemplary embodiment.

FIG. 5 is a block diagram of a system for producing local entity customized integrated missal bulletins wherein a supervisory production system receives base content from multiple base content origination systems and provides base content to multiple production systems each of which serves a plurality of local entities according to another exemplary embodiment.

FIG. 6 is a block diagram of a system for producing customized integrated missal bulletins according to another exemplary embodiment.

FIG. 7 is a block diagram of a computer system suitable for implementing the various methods and systems disclosed herein, according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

Before turning to the figures and the various exemplary embodiments illustrated therein, a detailed overview of various embodiments and aspects is provided for purposes of breadth of scope, context, clarity, and completeness.

It should be understood that the following description and the figures use as illustration a system for supporting the production of an integrated missal bulletin in a religious organization exemplary embodiment, but that the system and methods described herein are not limited to a religious organization embodiment. The systems and methods herein are applicable to a wide range of different organizational and relational systems applications. The exemplary embodiment of an integrated missal bulletin can be any document wherein each entity provides local content and incorporates base content having a plurality of portions selected by the local entity for production of customized integrated document or document file.

As described herein in the exemplary embodiment, base content includes a missal having a plurality of portions selected from the group consisting of ritual text, preface, rubric, praise, response, image, poem, chant, musical setting, participation aid, rite, scripture, prayer, music score, announcements, news, and advertisements. In some embodiments, each portion of the base content is assigned a unique base content portion reference identifier, and wherein each of the first and second base content portion reference identifiers is a different base content reference identifier. The portions of the base content are indexed or otherwise reference for searching, selection and extraction/copying as may be defined for use in the described process and systems. Of course in other embodiments, the base content and portions thereof can be any type of information. Furthermore, the base content can be text, graphic images, links to other data, software applications, and video clips, by ways of example, without intending to be limiting in any manner.

The base content and/or the local entity content can be periodically updated such as on a weekly or monthly basis. For example, in the local religious applications the base content can include missals and music scores to be used for a weekly religious service for each local church associated with the regional or national religious organization. This can also include the specification of the scriptures, etc. The base content can be received in any form and in some embodiments is provided by electronic means of communication or possibly by a web portal hosted by a national or production system that is established for receiving such base content.

The local entity content or simply local content can include, but is not limited to data such as agendas, schedules of events, advertisements, announcements, and news, by way of examples, as well as any of the above items listed as base content. For example, the local content can include local advertising, personal announcements for the local church, local announcements for events or activities or a calendar. The local entity content can be provided in any suitable means and can include, written text, electronic transmissions, facsimile, or via a hosted web portal, or other wise, and would in many embodiments, include the capability of receiving predefined and predesigned graphics and images for local marks, advertising, symbols, images, or pictures.

In one embodiment, a system for producing an integrated missal bulletin including a production system having a processor, a memory, a first interface, and a second interface. The first interface receives base content having a plurality of portions from a base content originator. In one embodiment, the first interface is communicatively coupled to a base content origination system associated with a supervisory religious entity and each of the first and second local content entities are local churches related to the supervisory religious entity, and wherein the received base content is first base content, and wherein the production system receives second base content and replaces the first base content as the base content stored in the memory. In this manner, the production system is capable of being updated with new base content.

In other embodiments, the production system may be configured to have a plurality of different base content that may be defined or specialized for use by predefined or a subset of local entities systems. In such a manner, the production system can be a repository for various base content for supporting a variety of different local entity systems associated with different organizations. For example, a single production system can have a first base content for a Catholic Church organization and its churches and second base content for a Lutheran Church organization and its churches.

The second interface receives local content from two or more different local content entities and for receiving local integration instructions from each of the two more different local content entities. The second interface can be any type of date interface to the production system suitable for such described functions. In one embodiment, the second interface is a web hosted graphical user interface (GUI) accessible over an Internet by a user of the local entity system. In such embodiments, the production system provides the web hosted GUI or a web portal or similar GUI for enabling the local entity system or a user thereof to provide the production system with local content and local integration instructions for production of their customized integrated missal bulletin.

Each of the local integration instructions includes one or more references to at least one of the plurality of portions of the base content. The production system has an integration module with computer readable instructions for operating of the processor, memory and first and second interface for performing the method of producing the integrated missal bulletin including receiving the base content at the first interface, storing the received base content in the memory, receiving over the second interface first local integration instructions and first local content from a first local content entity and second local integration instructions and second local content from a second local content entity.

The production system further is configured for selecting as a first base content portion a first portion of the base content corresponding at least one of the first base content portion references as a function of the first local integration instruction. The production system provides for the arranging of the first local content with the selected first base content portion as a function of the first local integration instruction, and creating a first integrated missal bulletin document file containing the arranged first local content with the selected first base content portion. This process is repeated or duplicated for second, third and other local entity systems for the production of their own customized integrated missal bulletin based on their own local content and their own local integration instructions and selected base content portions from among the plurality of all base content. In such a manner, the production system produces customized integrated missal bulletin document file that are unique and different based on the local content and local integration instructions for each local entity system.

In some embodiments, the production system can have additional interfaces and functionality based on those interfaces with additional systems. For example, in one embodiment the production system has a third interface communicatively coupled to a printer and having a production module with computer executable instructions for transmitting the first integrated missal bulletin document file over the third interface to the printer with instructions for printing of a plurality of first integrated bulletins therefrom.

For example, in one embodiment, each production system can be equipped with a digital press system with staple and folding capabilities, programmable (and possibly preprogrammed) computerized systems with publishing templates for the integrated missal bulletin, interne communications capabilities, and other software applications such as for word processing, publishing and printing, and networking. As one example of a digital press, such as system can include the capability for multiple color paper, multiple sizes of paper, printing, folding, and stapling and possibly even binding of the integrated missal bulletin. For example, in some embodiments, a production system with digital press can be configured for producing integrated missal bulletins for about 30 weekly integrated missal bulletins. Of course, a single production system can be equipped with or coupled to a plurality or the appropriate number of digital presses as may be required to support the responsible local entities and their coupled local entity systems for producing the required number of integrated missal bulletins.

As described herein, the production system can be configured, in some embodiments for compiling and printing the multiple integrated missal bulletins each of which is customized to each local entity but that includes and/or is based on the base content as provided by one or more remote base content originating centers or entities. The base content origination system (BCOS) can be any entity that is responsible for providing base content for periodic publications on a local basis. This can be a regional or national office center for a religious organization such as for production of weekly integrated missal and bulletin, or can be for any other form of publications including local newspapers or newsletters, by ways of example. The identification of an integrated missal and bulletin is used herein as one exemplary embodiment, and as such, a religious organizational example is described throughout. However, one skilled in the art will understand that the systems and methods as described herein would not be limited to missals and bulletins or religious applications in some other embodiments.

In another embodiment, the production system includes a third party content interface for receiving third party content having one or more portions from a third party. In such embodiments, the memory stores the received third party content. The local integration instructions can include a third party content portion reference to one of the portions of the third party content. The production system selects one portion of the plurality of portions of the third party content responsive to the local integration instruction reference, and arranges with the first local content the first selected portions of the base content and the elected portions of the third party content. As such, the integrated missal bulletin document file created by the production system includes the selected third party content portion.

In the alternative, the production system can transmits the first integrated missal bulletin document file over the second interface to the first local content entity rather than printing the paper documents locally. In some embodiments, such transmission may be to document production systems of third parties that have the responsibility, such as under contract, for the above described printing and production functions.

In some embodiments, a plurality of stored templates that can be displayed of the second interface or that can be selected by the user of the local entity system. Wherein the second interface of the production system is a graphical user interface, the second interface can be configured to enable a user of the local entity system to select one of the templates from among the plurality of stored templates.

In such embodiments, each template predefines a different arrangement of local entity content and portions of base content and each created integrated missal bulletin document file has a different format. The local integration instructions can include a template identifier associated with at least one of the stored templates such that upon receipt of the local integration instruction, the local content and the selected portions of the base content are arranged responsive to the template associated with the included template identifier.

In other embodiment, the second interface that is a graphical user interface can include a publisher formatting module for receiving user layout instructions. In such embodiments, the first local integration instruction includes the received user layout instructions and as a result the production system arranges the local content with the selected portions of the base content responsive to the user layout instructions included in the specific local integration instruction.

Similarly a method of producing an integrated missal bulletin using a production system as described above includes receiving over the second interface first local integration instructions and first local content from a first local content entity and second local integration instructions and second local content from a second local content entity. The method includes selecting as a first base content portion a portion of the base content corresponding at least one of the first content portion references as a function of the first local integration instruction, arranging the first local content with the selected first base content portion as a function of the first local integration instruction, and creating a first integrated missal bulletin document file containing the arranged first local content with the selected first base content portion.

The method also includes selecting as a second base content portion a portion of the base content corresponding at least one of the second base content portion references as a function of the second local integration instruction. The method also includes arranging the second local content with the selected second base content portion as a function of the second local integration instruction, and creating a second integrated missal bulletin document file containing the arranged second local content with the selected second base content portion. From such a method the second integrated missal bulletin document file is different than the first integrated missal bulletin document file, as each is customized by the local content on which it is based and on the local instructions including the uniquely identified base portion reference identifiers that selected unique portions of the base content.

The method also includes the various functions and processes as described above for the exemplary production system. For example, the method can include hosting a web hosted graphical user interface over the second interface that is accessible over an Internet by a first user associated with the first content entity, by way of example.

In another embodiment utilizing the system and method of the production system as described above, a system for producing an integrated missal bulletin having a base content origination system, a first and a second local entity system, and a production system.

The base content origination system having a base content processor, base content memory, a first origination system interface and a second origination system interface. The first origination system interface receives a plurality of base content portions from a plurality of base content originators or systems. The processor of the base content origination system receives the base content portions and compiles the received base content portions into base content including assigning each base content portion a base content portion reference identifier, These are stored as base content with the compiled base content portions in the memory and are transmitted as compiled base content with the associated base content portion reference identifiers over a second origination system interface to a production system or other entity as described herein.

The first local entity system has a first local entity processor, a memory, a first local user interface and a first local entity network interface. The first local interface receives first local entity content and first local integration instructions from a first user. The first local entity network interface transmits the received first local entity content and the first local integration instructions.

The second local entity system having a second local entity processor, a memory, a second local user interface and a second local entity network interface. The second local interface receives second local entity content and second local integration instructions from a second user. The second local entity network interface transmits the received second local entity content and the second local integration instructions. Each of the first and second local integration instructions includes one or more defined base content portion reference identifiers.

In some embodiments, the first local entity system includes a local communication interface communicatively coupled to at least one of a display system for locally displaying a first integrated missal bulletin from the first integrated missal bulletin document file and a local wireless server system for transmitting the first integrated missal bulletin document file to local or personal display devices for display of the first integrated missal bulletin thereon. In such embodiments, the integrated missal bulletin document file may be a text file or may be an html or similar file whereas local display devices can display the contents of the integrated missal bulletin in various desired formats for the users thereof.

The production system is as described above and interfaces with the local entity systems and the base content origination systems as described above. The production system has an integration module with computer readable instructions for configuring the processor, the memory and first and second interface of the production system for performing the method as described above for the production system.

In some embodiments, the base content origination system is associated with a supervisory religious entity and each of the first and second local entity systems are systems at local churches associated with the supervisory religious entity, and wherein the received base content is first base content, and wherein the production system receives second base content, the production system replacing the stored first base content with the second base content and using the stored second base content as the base content.

In another embodiment, a method of producing an integrated missal bulletin in a system having a base content origination system, a first and a second local entity system, and a production system.

The base content origination system performing the method of receiving over the first origination system interface a plurality of base content portions from one or more base content originators, and compiling the received base portions as base content including assigning each base content portion a base content portion reference identifier. The base content origination system also transmitting over the second origination system interface the compiled base content with the assigned based content portion reference identifiers over the second base content interface.

The base content origination system can also be associated with a supervisory system. For example, a supervisory system may be an overseeing religious organization or entity and each of the first and second local entity systems are systems of local churches associated with the supervisory religious entity. In such embodiments, the base content stored in the production system is first base content, wherein the production system receives second base content from the base content origination system and replaces the first base content with the second based content as the base content stored in the memory.

In some embodiments, the base content origination systems can be configured similar to the production systems as described above, except that is some such embodiments, the base content origination system may only be equipped with publishing software and data base applications and communication capabilities for preparing, receiving base content originator input, and transmitting the base content to the production system or to a coupled supervisory production system.

The first local entity system receiving first local entity content and first local integration instruction over the first local user interface, and transmitting the received first local entity content and the first local integration instructions over a first entity network interface. The second local entity system receiving second local entity content and second local integration instructions over the second local user interface, and transmitting the received second local entity content and the second local integration instructions over the second local entity network interface. The local entity systems can include a printer interface coupled to a local printer. In such embodiments, the local entity can provide for the printing of their own integrated missal bulletins based on the received first integrated missal bulletin document file.

In the embodiments where the local entity system includes a local communication interface communicatively coupled to at least one display system, the method can include displaying the integrated missal bulletin generated from the first integrated missal bulletin document file. In another embodiment, the local entity system includes a communication interface communicatively coupled to a local wireless server system. In such an embodiment, the method can include transmitting the first integrated missal bulletin document file in a format that is suitable for the local receiving and/or displaying devices for display thereon as a function of the received first integrated missal bulletin.

The production system performing the method as described above in conjunction with the interactions with the base content origination system and the local entity systems. The production system can be established for support of local organizations that geographically common so as to reduce the costs of transportation of printed publications to local entities serviced by the production systems. For example, in one embodiment it is envisioned that an PS can support a geographic area of approximately 60 miles in radius, wherein the integrated missal bulletin is printed in hard copy at the PS and physically delivered to the serving area of the PS. The PSs can be established and dedicated for local churches of a single religious affiliation or for multiple such affiliations or organizations. The location of a plurality of production systems can be based on multiple states or can be in a single metropolitan or similar geographic area.

In some embodiments, the production system can include a separate interface that is configured for transmitting an electronic version of each local customized integrated missal bulletin to electronic interfaces of the various applicable local entities. In such an embodiment, the local entity system can receive the electronic version and the local entity can use the local entity system to locally print its own integrated missal bulletin.

In other embodiments, a supervisory production system can act as a coordinator function or entity for coordinating two or more production systems. These supervisory production systems can also act as a national or center interface to the base content origination centers for receiving the base content, in whole or in part. The supervisory production system can also include or have stored a set of predefined acceptable content that can be predefined or established for integration with or use as base content. For example, this can include music scores that are predefined by an base content origination system. In this manner, the base content origination system can simply reference the particular piece of music from a library of predefined acceptable content. The production system or supervisory production system can then obtain the reference as received by the base content origination system and then insert predetermined music score for inclusion in the base content as forward for inclusion in the integrated missal bulletin.

Also, the production systems or supervisory production systems can also include a third party local content interface that is configured for receiving regional content from third parties. For example, this regional content can include advertising that is on a regional basis or can include other information including music scores, by way of example. The regional or supervisory production system can then integrate the received and applicable third party content with the base content and the local entity content for producing each of the customized integrated missal bulletins for each local entity.

As addressed above, the production system, alone or in combination with the supervisory production system, can be configured for compiling and printing the integrated missal bulletins customized for each local entity, and then the PS distributes the appropriate integrated missal bulletin to each local entity either as printed copies or its local entity system in electronic format.

As addressed above, the production systems include network communications with one or more base content origination systems/centers for receiving base content. The base content origination systems/centers can be a national church office, for example, that creates the base content for each weekly production. Base content can be provided by the one or more remote to act as the base for use in production of each weekly issue of the produced product. The produced product can be in the described exemplary embodiment an integrated missal and bulletin for use by a plurality of local user communities. The produced product includes the base content and local entity specific content. The local entity being a local parish, church, or chapter of an organization or otherwise. The local entity specific content being locally provided data, advertisements, new reports, calendar of events, by ways of example. The production system includes local entity interfaces for receiving the local entity specific content from each of the plurality of local user community systems. The local entity system interfaces can include computer internet networks and can include hosting a webpage for each local entity for posting of local entity specific content.

The production systems receive the base content from at least one of the base content origination systems and receive local entity specific content from each of the local user communities. The production system then integrates the local entity specific content with the base content for each of the local user communities and generates a separate and distinct product for that particular week. Each integrated publication can be produced weekly and then distributed to the corresponding local entity.

In another alternative embodiment, the production system can also receive regional or third party local content that is then integrated with the base and local user content and produced in the weekly product, e.g., regional or local advertisements or notices that apply to more than one local community, such as a group of geographically or administered churches.

As noted above, the base content can, in one embodiment, include missals and music to be used for a weekly religious service such that the base content is common to all members of a user community, or a local entity. Generally, the base content is considered to be standardized and therefore common to all integrated missal bulletins, even though each will also include local entity content, as well as possibly applicable regional or third party content. The base content can also include content that is predetermined by the base content origination system for appropriate copyright protection and/or licensing.

In operation, according to one embodiment, a method of producing an integrated missal bulletin includes receiving base content to be used for a particular service of a plurality of churches associated with the religious organization and receiving local entity content from each of the churches has a local entity system which is associated with the religious organization. The base content can be received from a regional or national office of a content provider or more than one content provider. For example, this can be one or more regional or national offices of a religious organization. Of course one of skilled in the art will also understand that the method could also be applied to multiple religious organizations once implemented and the infrastructure described put in place.

The method also includes compiling a different integrated missal bulletin for each of the plurality of churches by integrating the local entity content for each with the base content. For example, the method can include compiling the base content that is standardized by the regional or national office of the religious organization that is to be used by all churches within the religious organization such as for a particular weekly service. As described, this can include the subject matter and even the music of for each weekly service. The base content can be provided to the production system on a weekly basis and then combined with local, regional or third party content for customization for each local entity's use that is based on the base content. For example, this can be performed on a weekly basis such that the regional content provider, such as a regional office of a religious organization, can prepare and define the base content for that week's service and the local entity and possibly local or regional third party content providers can also provide their content.

The method further includes distributing to each of the plurality of churches a different weekly integrated missal bulletin that includes the same base content and the local entity content associated with each of the churches. For example, as described above, the integrated missal bulletin can be printed at a production system that is customized for each local entity and then locally distributed by mailing, shipping or otherwise the printed integrated missal bulletin to the particular local entity. This can be done weekly for each event or service.

In other embodiments, the distribution can be handled via an electronic communication interface between the production system and the local entity system. The entity system can be equipped with a local printer and compiled by local staff as the integrated missal bulletin product for use by the local entity and its users. The production system can be configured to transmit an electronic version of the integrated missal bulletin that has been customized for the particular one of the local entities using the local entity content integrated with base content and possibly with regional content and/or third party content via an electronic interface at the production system to an electronic interface at the local entity system. The local entity system would then be capable of allowing the local entity to print the integrated missal bulletin customized for its use responsive to a local entity system receiving the transmitted electronic version of the produced integrated missal bulletin.

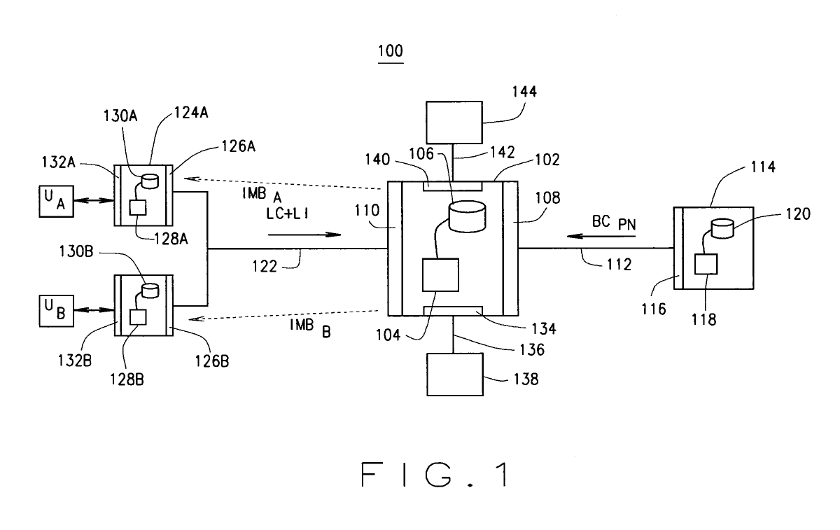

Referring now to the figures, as shown in FIG. 1 the system 100 includes a production system 102 (PS) that includes a processor 104, a memory 106, a first interface 108 and a second interface 110. Such computer systems include software containing executable instructions for performing the functions and processes as will be described herein. The first interface 108 is configured for connection to a communication link 112 for communicating with a base content origination system 114 via its interface 116. Interface 116 can be any type of suitable interface including any format of data communication interface, web portal or the like. The base content origination system 114 (BCOS) also includes its own processor 118 and memory 120. The BCOS 114 stores and transmits Base Content (BC) to the PS 102. Such BC includes a plurality of base content portions, each of which is uniquely identified by a base content portion reference identifier (RI_{BC}). The PS 102 receives the BC at its first interface 108 and stores it in memory 106 including storing all portions of the BC and the associated base content portion reference identifier (RI_{BC}). The processor 104 and memory 106 are configured with software such as database software whereby each portion of the BC can be uniquely identified by its RI_{BC} and separately extracted from the memory 106 by the processor 104 when selected thereby. The second interface 110 can be any type of suitable data communication interface including a hosted web interface accessible over an Internet. The second interface 110 is coupled to a communication link 122 for receiving base content (BC) and location instructions (LI) from one or more local entity systems 124 (shown as 124A and 124B), each of which is referred hereafter as LES 124.

Each LES 124 is computer system having a processor 128, a memory 130, a network interface 126, and a user interface 132. Each LES 124 has its own computer software configured for performing the methods as a local entity system 124 as described herein. The LES 124 receives local content (LC) from a user U_{N} over the user interface 132 which can be any type of input capable of a personal computer including manually entered data, scanned data, electronically input text and graphical data or the like. The LC is stored in the memory 130 as compiled by the processor 128 based on input and instructions from the user U_{N}. Additionally, the LES 124 receives input from the user U_{N} with regard to local instructions (LI) for creating an integrated missal bulletin using the LC. The LI can include directions for arrangement of some or all of the LC, for identifying portions of the local content by reference identifier (RI_{LC}) for identifying specific portions of BC as stored and managed by the PS 102 such as by name or by base content portion reference identifier RI_{BC}, document forms and formats, and assembly and distribution instructions. The LIs are created by the processor 128, stored in memory 130. The processor 128 provides for the transmission of the LC and LI over the network interface 126 to the PS 102. As shown, there can be a plurality of LES 124 systems communicatively coupled to the PS 102.

In some embodiments, the PS 102 includes a printer interface 134 communicatively coupled to printer communications link 136 and to printer 138. The printer interface 134 can transmit the created integrated missal bulletin document file to the printer 138 for printing of a plurality of integrated missal bulletins therefrom and consistent with the instructions for such printer as provided in the LI.

In some embodiments, the PS 102 also includes a third party content interface 140 communicatively coupled via communication link 142 to a third party content origination system 144 that could be a third party content system (as will also be addressed herein as well as local content systems) as related third party entities or authorized users of the PS 102. In such embodiments, the LI can include an instruction for including portions of third party content RI_{TPC} in the complied and created integrated missal bulletin document file.

After receiving both the BC, the LC, and the LI, the PS 102 produces an integrated missal bulletin document file following the document preparation instructions as provided in the LI an using the provided LC and identified selected portions of the BC. The process is as described below in detail. After the integrated missal bulletin document file is created for the requesting LES, the PS 102 can product the actual integrated missal bulletin (IMB) by printing paper copies at the printer 138 and can then mail or have delivered the printed copies to the local entity at which the LES is located or another identified address pursuant to the LI. In the alternative, the IMB document file can be transmitted by the PS 102 to the LES 124, such as via the second interface 110. In this later embodiment, the LES 124 can be configured for printing of the IMB locally, or can be configured for displaying the IMB on local displays for viewing, or can be transmitted over a local communication network, such as a local wireless network of user controlled devices for personal viewing of the IMB.

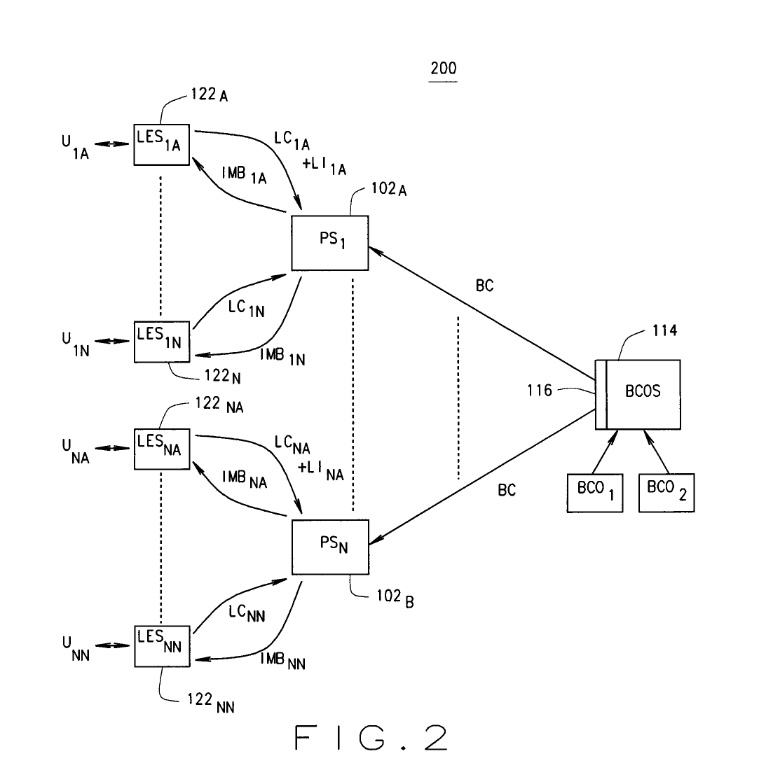

FIG. 2 illustrates another embodiment, system 200 that has multiple PS 102 systems (shown as PS 102₁ and PS 102_{N}) that each receive the same base content (BC) from the same base content origination system 114). Additionally, system 200 includes two or more base content originators (BCO) (that could be persons, other BCOSs, or base content originator systems that define or otherwise provide some or all of the portions of the BC to the BCOS 114.

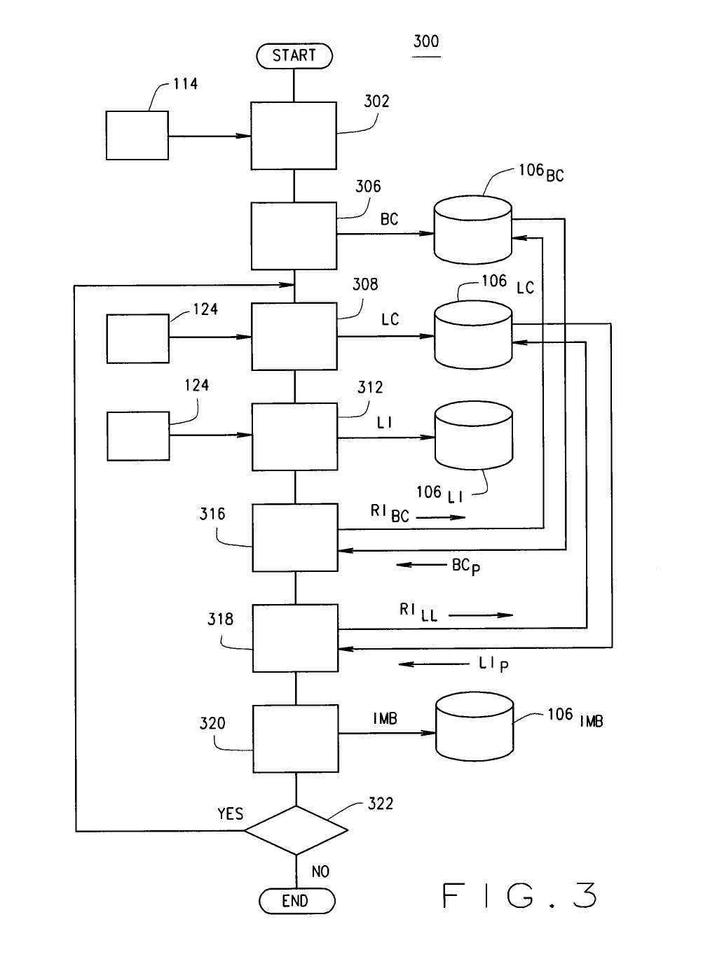

FIG. 3 is a flow chart of a process 300 that can be implemented by the PS 102. The process begins at step 302 wherein the PS 102 receives BC from base content origination system 114. The PS 102 stores the BC in memory 106_{BC} in step 306 including storing each base content portion and each base content portion reference identifier as described above. From time to time, the PS 102 receives LC from LES 124 and stores the LC in memory 106_{LC} in step 308. The PS 102 also receives LI from LES 124 in step 312 and stores the LI in memory 106_{LI}. The processor 104 following its executable instructions that includes utilizing the document preparation instructions as provide by the LES 124 in each LI. This includes selecting and retrieving base content portions from the memory 106_{BC} such as by transmitting one or more base content portion reference identifiers RI_{BC} or RI_{BCP} as provided in the LI to the memory 106 (shown here as 106_{BC} for the memory with the base content stored therein) and receiving the associated base content portions as in step 316. Next the processor 104 can retrieve all or a portion of the LI stored in the memory 106_{LI} and arranges the LC with the selected portions of the BC pursuant to the LI for such arrangement as shown in step 316. Step 318 illustrates that at times, some portions of the LI can be retrieved from the memory 106_{LI} during this process. The processor 104 utilizes the LI, the LC or portions thereof, and the selected base content portions based on RI_{BCP} or RI_{BC} for creating the integrated missal bulletin (IMB) document file in step 318. The created IMB document file can be stored in memory 106_{IMB} for subsequent transmission, printing or for filing. The method 300 then checks if LC and/or LI is received from another LES 124 in step 322. If no other LC or LI is received the process ends. However, if and when additional or updated LC or LI is received by the PS 102, the process returns to step 308 for processing of a different IMB document file consistent with the subsequently received LC or LI.

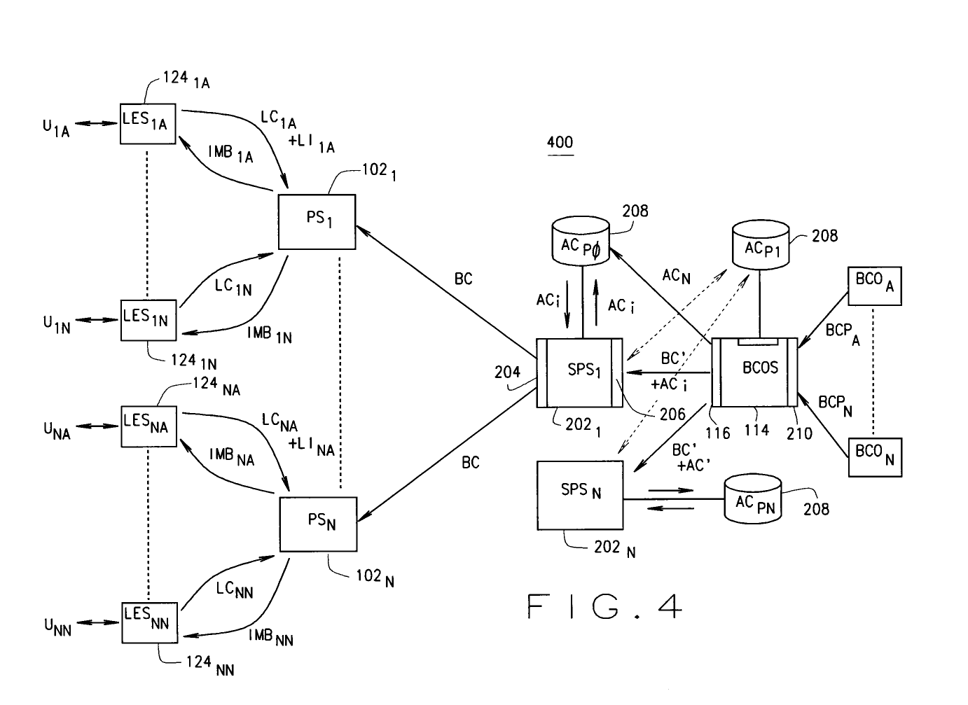

FIG. 4 illustrates an additional embodiment a system 400 consistent with this disclosure. As shown in FIG. 4, multiple PS 102 systems received base content from a supervisory production system (SPS) 202 rather than directly from the BCOS 114. The SPS 202 includes an interface 204 for communicating to one or more PS 102.

The SPS 204 may be a supervisory system in a hierarchical production system such as that may be associated with a hierarchical organization. For instance, by way of example, the PS1 102₁ and PSN 102_{N} as shown in FIG. 4 may be production systems associated with regional or geographically defined groups of local content users having the LES 124 systems. The SPS may be a national office to which each of the regional or geographically defined local content user groups are subordinate. In such an embodiment, the SPS provides an added function of compiling the various portions of the base content into the BC provided to each PS.

System 400 also illustrates that there may be a plurality of SPS 204 systems each of which may receive portions of the BC from the BCOS 114. In some embodiments, one or more of the PS 102, the SPS 202, and BCOS 114 can include an interface to an approved content storage 208 wherein some of the portions of the base content are approved content (AC). The AC is stored as AC_{N} and can be retrieved by any of the PS 102, the SPS 202 and the BCOS 114 systems as portions of BC that is provided to the PS 102 systems. As noted above, all such provided AC is provided with a base content portion reference identifier RI_{BC or} RI_{BC} for uniquely identifying the AC within the BC.

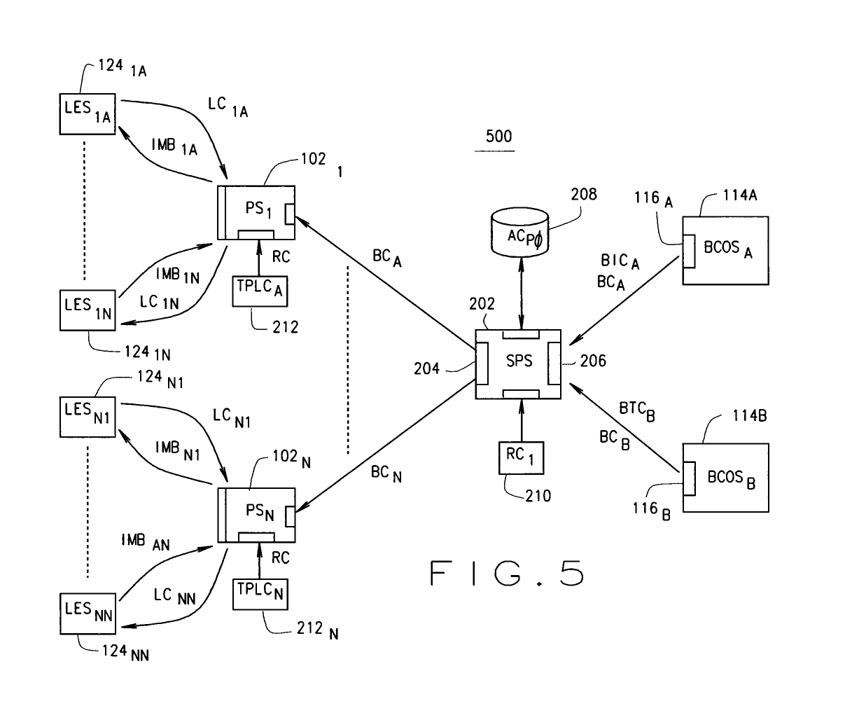

FIG. 5 illustrates additional exemplary embodiment system 500 having an SPS 202 including interface 206 for receiving base content portions from a plurality of BCOS 114 (illustrated herein as BCOS_{A} 114A and BCOS_{B} 114B). Additionally, the SPS 202 can be coupled to a regional content (RC) system 210 for receiving regional content that becomes portions of the base content that is transmitted to each PS 102 within the applicable region of the RC system 210. This can be based on organization such as religious affiliation or denomination or by geographic area. The RC can be any content including data, advertisements, announcements, events, schedules, and the like.

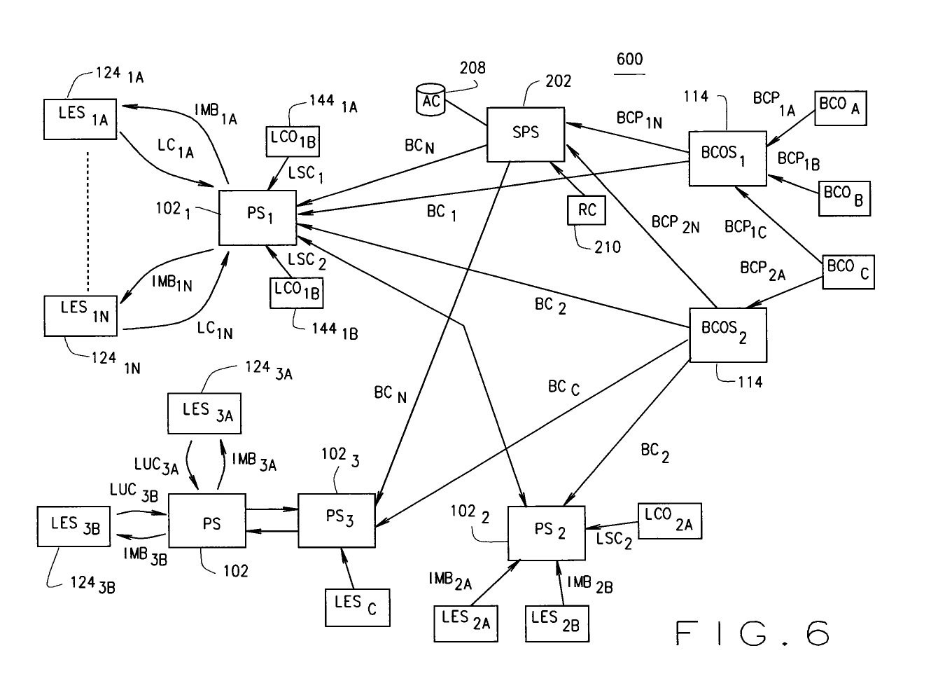

FIG. 6 illustrates yet another complex multi-hierarchical exemplary embodiment of system 600. As shown in FIG. 6, system 600 includes multiple BCOS 114 systems have varying links to both SPS 202 as well as directly with PS 102. In this embodiment, each PS 102 receives portions of base content not only from local content originators using third party origination systems (LCO) 144, but also from third party local content provider systems (TPCS) 212, directly from the SPS 202, other PS 102 systems and also from one or more BCOS 114. In such an embodiment, each PS 102 acts as a collector and repository of various portions of base content that is stored as based content by the PS 102 which can be selected by each LES 124 by means of including a base content portion reference identifier for such portion in its LI. As such, each local entity having an LES 124 can select among base content that is provided by multiple sources such that the integrated missal bulletin document file that is created by the PS 102 for that local entity is completely customized for that local entity.

Of course, each local entity can utilize its LES 124 and the input from a user U_{N} of the LES 124 to limit the types or portions of base entity for which a LI includes in the various reference identifiers (RI_{N}) as described herein, and in particular the base content portion reference identifier RI_{BC}. Rules and restrictions for each LES 124, PS 102, SPS 202, LCO 144, TPCS 212, AC 208, RC 210 and BCO can be defined in software and computer executable instructions as may be desired by a particular application of the embodiments of this disclosure and still be within the scope hereof

### Operational Computer Environment

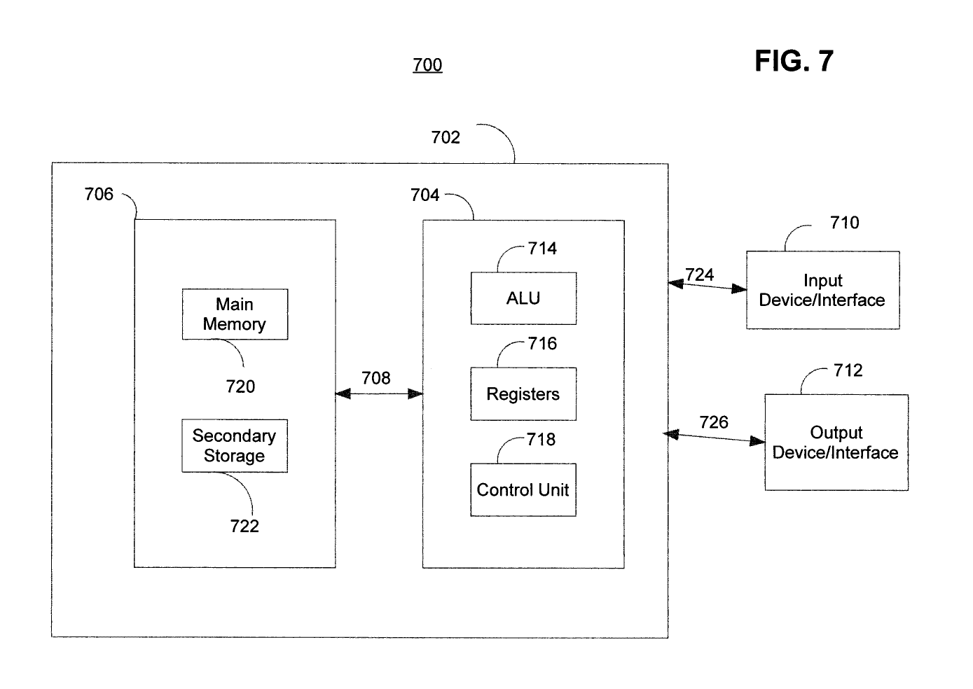

Referring to FIG. 7, an operating environment is illustrated as one embodiment of one or more of the production system (PS), supervisory production system (SPS), base content origination centers (BCOS), or local entity systems (LES), or otherwise as described herein, alone or in combination. Such an operating environment includes a computer system 500 with a computer 502 that comprises at least one high speed processing unit (CPU) 504, in conjunction with a memory system 506 interconnected with at least one bus structure 508, an input device 510, and an output device 512. These elements are interconnected by at least one bus structure 512.

The illustrated CPU 504 is of familiar design and includes an arithmetic logic unit (ALU) 514 for performing computations, a collection of registers 514 for temporary storage of data and instructions, and a control unit 516 for controlling operation of the system 500. Any of a variety of processors, including at least those from Digital Equipment, Sun, MIPS, Motorola, NEC, Intel, Cyrix, AMD, HP, and Nexgen, is equally preferred for the CPU X. The illustrated embodiment of the invention operates on an operating system designed to be portable to any of these processing platforms.

The memory system 506 generally includes high-speed main memory 520 in the form of a medium such as random access memory (RAM) and read only memory (ROM) semiconductor devices, and secondary storage 522 in the form of long term storage mediums such as floppy disks, hard disks, tape, CD-ROM, flash memory, etc. and other devices that store data using electrical, magnetic, optical or other recording media. The main memory 520 also can include video display memory for displaying images through a display device. Those skilled in the art will recognize that the memory system 506 can comprise a variety of alternative components having a variety of storage capacities.

The input device 510 and output device 512 are also familiar. The input device 510 can comprise a keyboard, a mouse, a graphics user interface, a web portal, a physical transducer (e.g. a microphone), etc. and is interconnected to the computer 502 via an input interface 524. The output device 512 can comprise a display, a printer, a transducer (e.g. a speaker), etc, a web portal, and be interconnected to the computer 502 via an output interface 526. Some devices, such as a network adapter or a modem, can be used as input and/or output devices.

As is familiar to those skilled in the art, the computer system 500 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 506.

In accordance with the practices of persons skilled in the art of computer programming, the present invention is described below with reference to symbolic representations of operations that are performed by the computer system 500. Such operations are sometimes referred to as being computer-executed. It will be appreciated that the operations which are symbolically represented include the manipulation by the CPU 504 of electrical signals representing data bits and the maintenance of data bits at memory locations in the memory system 506, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 506.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A system for producing an integrated missal bulletin comprising:
a base content origination system having a base content processor, base content memory, a first origination system interface and a second origination system interface, the first origination system interface receiving a plurality of base content portions, the processor receiving the base content portions and compiling the base content portions into base content including assigning each base content portion a base content portion reference identifier, and storing the base content with the compiled base content portions in the memory and transmitting the compiled base content with the associated base content portion reference identifiers over a second origination system interface;
a first local entity system having a first local entity processor, a memory, a first local user interface and a first local entity network interface, the first local interface receiving first local entity content and first local integration instructions from a first user, the first local entity network interface transmitting the received first local entity content and the first local integration instructions;
a second local entity system having a second local entity processor, a memory, a second local user interface and a second local entity network interface, the second local interface receiving second local entity content and second local integration instructions from a second user, the second local entity network interface transmitting the received second local entity content and the second local integration instructions;
each of the first and second local integration instructions including one or more defined base content portion reference identifiers;
a production system having a processor, a memory, a first interface receiving the transmitted compiled base content, and a second interface for receiving the first local content and first local integration instructions from the first local entity system and the second local content and second local integration instructions from the second local entity system, the production system having an integration module with computer readable instructions for configuring the processor, the memory and first and second interface of the production system for performing the method of:
receiving the compiled base content at the first production system interface,
storing the received compiled base content in the memory including each associated base content portion reference identifiers,
receiving over the second production system interface the first local integration instructions and the first local content from the first local entity system and the second local integration instructions and the second local content from the second local entity system,
selecting a first base content portion from the base content responsive to the first base content portion reference identifier as provided by the first local integration instruction,
arranging the first local content with the first selected base content portion,
creating a first integrated missal bulletin document file containing the arranged first local content with the selected first base content portion,
selecting a second base content portion from the base content responsive to the second base content portion reference identifier as provided by the second local integration instruction,
arranging the second local content with the second selected base content portion,
creating a second integrated missal bulletin document file containing the arranged second local content with the selected second base content portion, the second integrated missal bulletin document file being different than the first integrated missal bulletin document file;
producing a first integrated missal bulletin from the created first integrated missal bulletin document file; and
producing a second integrated missal bulleting from the created second integrated missal bulletin document file.

2. The system of claim 1 wherein the production system having a third interface communicatively coupled to a printer and having a production module with computer executable instructions, wherein the producing of the first integrated missal bulletin document file including transmitting the first integrated missal bulletin document file over the third interface to the printer for printing of a plurality of first integrated missal bulletins therefrom.

3. The system of claim 1 wherein producing the first integrated missal bulleting includes the production system transmitting the first integrated missal bulletin document file over the production system second interface and receiving the first integrated missal bulletin document file by the first local entity system over the local entity network interface.

4. The system of claim 3 wherein the first local entity system includes a printer interface and wherein the printer interface is coupled to a local printer for printing a plurality of first integrated missal bulletins from the received first integrated missal bulletin document file.

5. The system of claim 1 wherein the first local entity system includes a local communication interface communicatively coupled to at least one of a display system for locally displaying a first integrated missal bulletin from the first integrated missal bulletin document file and a local wireless server system for transmitting the first integrated missal bulletin document file to local receiving devices for display of the first integrated missal bulletin thereon.

6. The system of claim 1 wherein the base content origination system is associated with a supervisory religious entity and each of the first and second local entity systems are systems at local churches associated with the supervisory religious entity, and wherein the received base content is first base content, and wherein the production system receives second base content, the production system replacing the stored first base content with the second base content and using the stored second base content as the base content.

7. The system of claim 6 wherein the base content includes a missal having a plurality of portions selected from the group consisting of ritual text, preface, rubric, praise, response, image, poem, chant, musical setting, participation aid, rite, scripture, prayer and music score, each of which is assigned a unique base content portion reference identifier, and wherein each of the first and second base content portion reference identifiers is a different base content reference identifier.

8. The system of claim 1 wherein the local entity content includes data selected from the group consisting of a schedule of events, an agenda, a local advertisement, a local announcement, and an identification of an event.

9. The system of claim 1 wherein the production system includes a third party content interface for receiving third party content having one or more portions from a third party, the memory storing of the received third party content, and at least one of the first and second local integration instructions includes a reference to one of the portions of the third party content, wherein the production system implements that method including selecting at least one of the plurality of portions of the third party content responsive to the local integration instruction reference, and wherein the arranging of the first local content with the first selected portions of the base content includes arranging the at least one of the plurality of portions of the third party content and wherein creating the first integrated missal bulletin document file includes creating the first integrated missal bulletin document file containing the arranged third party content with the first local content and the first selected portions of the base content.

10. The system of claim 1 wherein the production system memory includes a plurality of stored templates each having a unique template identifier, each template predefining a different arrangement of local entity content and portions of base content and each created first and second integrated missal bulletin document file has a different format, wherein the first local integration instruction includes a first template identifier associated with at least one of the stored templates, and wherein arranging the first local content with the first selected base content portion is responsive to the template associated with the included first template identifier.

11. The system of claim 1 wherein the production system second interface is a web hosted graphical user interface accessible over an Internet by a first user associated with the first content entity, and wherein the first local entity system is a local computer configured for accessing and viewing of the web hosted graphical user interface.

12. The system of claim 11 wherein the production system memory includes a plurality of stored templates each having a unique template identifier, each template predefining a different arrangement of local entity content and portions of base content and each created first and second integrated missal bulletin document file has a different format, wherein the graphical user interface includes a user selection feature enabling the user to select one of the templates from among the plurality of stored templates, wherein the first local integration instruction includes a first template identifier associated with at least one of the stored templates, and wherein arranging the first local content with the first selected portions of the base content is responsive to the template associated with the included first template identifier.

13. The system of claim 11 wherein the graphical user interface includes a publisher formatting module for receiving user layout instructions, wherein the first local integration instruction includes the received user layout instructions and wherein the arranging the first local content with the first selected base content portions is responsive to the user layout instructions included in the first local integration instruction.

14. A method of producing an integrated missal bulletin comprising:
in a base content origination system having a base content processor, base content memory, a first origination system interface and a second origination system interface:
receiving over the first origination system interface a plurality of base content portions from one or more base content originators,
compiling by the processor the received base portions as base content including assigning each base content portion a base content portion reference identifier,
transmitting over the second origination system interface the compiled base content with the assigned based content portion reference identifiers over the second base content interface;
in a first local entity system having a first local entity processor, memory, first local user interface and a first entity network interface:
receiving first local entity content and first local integration instruction over the first local user interface, and
transmitting the received first local entity content and the first local integration instructions over a first entity network interface;
in a second local entity system having a second local entity processor, memory, second local user interface and a second entity network interface:
receiving second local entity content and second local integration instructions over the second local user interface, and
transmitting the received second local entity content and the second local integration instructions over the second local entity network interface;
each of the first and second local integration instructions including one or more defined base content portion reference identifiers;
in a production system having a processor, a memory, a first interface and a second interface and an integration module with computer readable instructions for configuring the processor, memory and first and second interfaces:
receiving over the first interface the transmitted compiled base content with the based content portion reference identifiers, and
receiving over the second interface the first local content and first local integration instructions from the first local entity system and the second local content and second local integration instructions from the second local entity system, the integration module performing the method of:
receiving the compiled base content at the first interface including the associated base content portion reference identifiers,
storing the received compiled base content in the memory along with the associated base content portion reference identifiers,
receiving over the second interface the first local integration instructions and the first local content from the first local entity system and the second local integration instructions and the second local content from the second local entity system,
selecting a first base content portion from the base content responsive to the first base content portion reference identifier as provided by the first local integration instruction,
arranging the first local content with the first selected portions of the base content, creating a first integrated missal bulletin document file containing the arranged first local content with the selected first base content portions,
selecting a second base content portion from the base content responsive to the second base content portion reference identifier as provided by the second local integration instruction,
arranging the second local content with the second selected portions of the base content,
creating a second integrated missal bulletin document file containing the arranged second local content with the selected second base content portions, the second integrated missal bulletin document file being different than the first integrated missal bulletin document file,
producing a first integrated missal bulletin from the created first integrated missal bulletin document file; and
producing a second integrated missal bulleting from the created second integrated missal bulletin document file.

15. The method of claim 14 wherein the production system has a third interface communicatively coupled to a printer and having a production module with computer executable instructions, wherein producing the first integrated missal bulletin includes transmitting the first integrated missal bulletin document file over the third interface to the printer for printing of a plurality of first integrated missal bulletins therefrom.

16. The method of claim 14 wherein in the production system the producing of the first integrated missal bulleting including transmitting the first integrated missal bulletin document file over the production system second interface, and further comprising, in the first local entity system, receiving the transmitted first integrated missal bulletin document file.

17. The method of claim 16 wherein the first local entity system includes a printer interface and wherein the second interface is coupled to a local printer, the method further comprising printing a plurality of first integrated missal bulletins from the received first integrated missal bulletin document file.

18. The method of claim 14 wherein the first local entity system includes a local communication interface communicatively coupled to at least one display system, further comprising locally displaying a first integrated missal bulletin generated from the first integrated missal bulletin document file.

19. The method of claim 14 wherein the first local entity system includes a communication interface communicatively coupled to a local wireless server system, further comprising transmitting the first integrated missal bulletin to local receiving devices for display thereon as a function of the received first integrated missal bulletin.

20. The method of claim 14 wherein the base content origination system is associated with a supervisory religious entity and each of the first and second local entity systems are systems of local churches associated with the supervisory religious entity, and wherein the base content is first base content, further comprising, in the production system, receiving second base content and replacing the first base content with the second based content as the base content stored in the memory.

21. The method of claim 14 wherein the base content includes a missal having a plurality of portions selected from the group consisting of ritual text, preface, rubric, praise, response, image, poem, chant, musical setting, participation aid, rite, scripture, prayer and music score, each of which is assigned a unique base content portion reference identifier, and wherein each of the first and second base content portion references is a different base content portion reference identifier.

22. The method of claim 14 wherein the local entity content includes data selected from the group consisting of an agenda, local advertising, local announcements, an identification of events, and a calendar of events.

23. The method of claim 14 wherein the production system includes a third party content interface, the method comprising receiving third party content at the production system having one or more portions from a third party, the memory storing of the received third party content, and at least one of the first and second local integration instructions includes a reference to one of the portions of the third party content, wherein in the production system the method further comprises selecting at least one of the plurality of portions of the third party content responsive to the local integration instruction reference, and wherein the arranging of the first local content with the first selected portions of the base content includes arranging the at least one of the plurality of portions of the third party content and wherein the creating of the first integrated missal bulletin document file includes creating the first integrated missal bulletin document file containing the arranged third party content with the first local content and the first selected portions of the base content.

24. The method of claim 14 wherein the production system memory includes a plurality of stored templates, each template predefining a different arrangement of local entity content and portions of base content and each created first and second integrated missal bulletin document file has a different format, wherein the first local integration instruction includes a template identifier associated with at least one of the stored templates, and wherein the arranging of the first local content with the first selected portions of the base content is responsive to the template associated with the included template identifier.

25. The method of claim 14 wherein the production system second interface is a web hosted graphical user interface accessible over an Internet by a first user associated with the first content entity, and wherein the first local entity system is a local computer, further comprising accessing and viewing of the web hosted graphical user interface.

26. The method of claim 27 wherein the production system memory includes a plurality of stored templates, each template predefining a different arrangement of local entity content and portions of base and each created first and second integrated missal bulletin document file has a different format, wherein the graphical user interface includes a user selection feature enabling the user to select one of the templates from among the plurality of stored templates, wherein the first local integration instruction includes a template identifier associated with at least one of the stored templates, the method further comprising selecting one of the templates from among the plurality of stored templates using the user selection feature of the graphical user interface, wherein the arranging of the first local content with the first selected portions of the base content is responsive to the template associated with the included template identifier.

27. The method of claim 27 wherein the graphical user interface includes a publisher formatting module, the method further comprising receiving user layout instructions over the graphical user interface, wherein the first local integration instruction includes the received user layout instructions and wherein the arranging of the first local content with the first selected portions of the base content is responsive to the user layout instructions included in the first local integration instruction.
